(19) United States
(12) Patent Application Publication
(10) Pub. No.: US 2006/0060047 A1
(43) Pub. Date: Mar. 23, 2006

(54) Stripper attaching and removing mechanism for punch tool

(75) Inventor: Shigeharu Ichikawa, Niwa-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/222,973

(22) Filed: Sep. 12, 2005

(30) Foreign Application Priority Data
Sep. 21, 2004 (JP) 2004-273127

(51) Int. Cl. B26F 1/14

(52) U.S. Cl. 83/140; 83/552

(57) ABSTRACT

The present invention provides a stripper attaching and removing mechanism for a punch tool 4 which allows a stripper 37 to be easily attached and removed and which also allows components to be easily assembled together. A punch tool 4 has an inner hole 19 through which a punch 17 can be slid. The punch tool 4 includes a punch guide 18 having a lower end to and from which a stripper 37 can be attached and removed. A stripper cap ring 36 is rotatively movably fitted into the inner periphery of lower end of the punch guide 18, and the stripper cap ring 36 has an inner peripheral hole 38 in which the stripper 37 is held. Radial holes 39 are formed in a peripheral wall of the stripper cap ring 36. Steel balls 40 are inserted into the respective radial holes 39, and each of the steel balls 40 has a diameter larger than the thickness of the peripheral wall. Concave portions 42 and 41 are formed in the stripper 37 and punch guide 18 so as to be concave in a radial direction and so that the steel balls 40 can partly advance into the respective concave portions 42 and 41. The concave portions 41 is formed partly in the punch guide 18 in a peripheral direction.

### FIELD OF THE INVENTION

The present invention relates to a stripper attaching and removing mechanism for a punch tool which is used in a punch press to cooperate with a die tool in machining a plate material.

### BACKGROUND OF THE INVENTION

In a known example of a general configuration of a punch tool used in a punch press, a punch can be slid through an inner hole in a cylindrical punch guide. Further, a stripper is provided at the lower end of the punch guide so that the punch can penetrate the stripper. The stripper is pressed against a plate material when the punch is pushed down by a ram to punch the plate material. When the punch starts to rise after having completed the punching, the stripper remains pressed against the plate material owing to for example, the urging force of a spring during a predetermined rising interval before the punch completely leaves the plate material. This enables the punch to reliably leave the plate material. In this manner, the stripper is a part pressed against the plate material for each punching operation. The stripper thus has a shorter lifetime than other parts and must be frequently replaced with a new one. Thus, the stripper is detachably attached to the punch guide.

An example of a stripper attaching and removing mechanism has been proposed which is used for the above purpose and which is shown in an exploded perspective view in FIG. 6 (Japanese Patent No. 2732547 (U.S. Pat. No. 5,301,580)). This figure shows how the stripper is replaced with a new one. The position of the stripper shown in the figure is vertically opposite to that in which the stripper is used. A stripper 61 is placed at the lower end (in the figure, upper end) of a punch guide 60. An annular stripper cap 62 is rotatably fitted around the outer periphery of the lower end of the punch guide 60. A C-shaped wire ring 63 is placed along the periphery of the stripper 61. One end 63a of the wire ring 63 is locked in a hole 60a in the punch guide 60. The other end 63b of the wire ring 63 is locked in a hole 62a in the stripper cap 62.

With the stripper attaching and removing mechanism, when the stripper cap 62 is at a predetermined rotative movement position with respect to the punch guide 60, the wire ring 63 is squeezed to reduce the diameter of the ring. This inhibits the stripper 61 from slipping out of the punch guide 60. When the stripper cap 62 is rotatively moved a predetermined distance from the above rotative movement position, the diameter of the wire ring 63 is increased to cancel the function for inhibiting the stripper from slipping out.

However, with the above stripper attaching and removing mechanism, when the wire ring 63 is replaced with a new one because its life expectancy is to be reached, or is disassembled for maintenance, the opposite ends 63a, 63b of the wire ring 63 must be locked in the hole 60a in the punch guide 60 and the hole 62a in the stripper cap 62. This locking operation is difficult and it takes a long time to assemble the wire ring 63, the punch guide 60, and the stripper cap 62 together. Further, the wire ring 63 is a thin part and a load acts on the wire ring 63 during punching. Consequently, the wire ring 63 may need to be replaced with a new one before the lifetime expectancy of the punch tool is reached. However, since the wire ring 63 is a dedicated part, it does not become available immediately. Accordingly, the wire ring 63 must be ordered from a punch tool manufacturer or the like.

It is an object of the present invention to provide a stripper attaching and removing mechanism for a punch tool which allows a stripper to be easily attached and removed and which also allows components to be easily assembled, the mechanism allowing common parts to be used as replacements for locking. It is another object of the present invention to enable the stripper to be reliably supported. It is yet another object of the present invention to prevent a locking steel ball from falling once the stripper cap ring has been assembled, thus further facilitating assembling operations.

### SUMMARY OF THE INVENTION

The present invention provides a stripper attaching and removing mechanism for a punch tool comprising a punch guide having an inner hole through which a punch can be slid and having a lower end to and from which a stripper can be attached and removed, the stripper attaching and removing comprising a stripper cap ring rotatively movably fitted into an inner periphery of a lower end of the punch guide, the stripper cap ring having an inner peripheral hole used to hold a stripper. A radial hole is formed in a peripheral wall of the stripper cap ring so that a steel ball having a diameter larger than the thickness of the peripheral wall is inserted into the radial hole. The stripper and the punch guide have concave portions into which the steel ball can partly advance and which is concave in a radial direction. The concave portion is formed partly in the punch guide in a peripheral direction. With this configuration, the steel ball having the diameter larger than the thickness of the peripheral wall is inserted into the radial hole in the peripheral wall of the stripper cap ring. When the steel ball is located in a part of the inner peripheral surface which does not correspond to the concave portion formed partly in the punch guide, the inner peripheral surface inhibits the steel ball from moving outward in a radial direction. The part of the steel ball having advanced into the concave portion in the stripper remains there. Thus, the stripper is clamped to the stripper cap ring via the steel ball. When the stripper cap ring is rotated so that its radial hole is aligned with the radial concave portion in the punch guide, the steel ball can partly escape to the radial concave portion in the punch guide. This cancels the clamping of the stripper by the steel ball.

In this manner, the stripper is attached to and removed from the stripper cap ring by rotating the stripper cap ring with respect to the punch guide to engage and disengage the steel ball between the concave portion in the punch guide and the concave portion in the stripper. Consequently, the stripper can be easily attached and removed. Further, during initial assembly or assembly following disassembly, the steel ball, serving as a locking part, has only to be placed in the radial hole. This allows the components of the stripper attaching and removing mechanism to be easily assembled together. The steel ball, serving as a locking part, must more frequently be replaced with a new one than the other components of the stripper attaching and removing mechanism. However, steel balls in a rolling bearing can be used for the present invention; the steel ball is easily available from a store for general mechanical parts.

In the present invention, a plurality of the radial holes may be formed in the stripper so as to be spaced from one another in a circumferential direction, and a plurality of the concave portions may be formed in the punch guide in the peripheral direction in association with the radial holes. The plurality of radial holes formed in the circumferential direction enable the stripper to be supported at a plurality of positions in the circumferential direction using the steel balls. Therefore, the stripper can be reliably supported.

In the present invention, an opening of each of the radial holes in the stripper cap ring which opening is closer to the stripper may have a diameter smaller than that of the steel ball so as to prevent the steel ball from slipping out of the radial hole. The small opening prevents the steel ball from slipping inadvertently out of the radial hole even when the stripper is removed from the stripper cap ring. This facilitates the subsequent attachment of the stripper.

The present invention provides the stripper attaching and removing mechanism for a punch tool comprising the punch guide having the inner hole through which the punch can be slid and having the lower end to and from which the stripper can be attached and removed, the stripper attaching and removing comprising the stripper cap ring rotatively movably fitted into the inner periphery of the lower end of the punch guide, the stripper cap ring having the inner peripheral hole used to hold a stripper. The radial hole is formed in a peripheral wall of the stripper cap ring so that the steel ball having a diameter larger than the thickness of the peripheral wall is inserted into the radial hole. The stripper and the punch guide have the concave portions into which the steel ball can partly advance and which is concave in a radial direction. The concave portion is formed partly in the punch guide in the peripheral direction. This configuration allows the stripper to be easily attached and removed and also allows the components to be easily assembled together. General parts can be used as replacements for locking and are easily available. If a plurality of the radial holes in the stripper cap ring are spaced from one another in a circumferential direction, and a plurality of the concave portions in the punch guide are formed in the peripheral direction in association with the radial holes, the stripper can be reliably supported at a plurality of points in the circumferential direction. If the opening of each of the radial holes in the stripper cap ring which opening is closer to the stripper has a diameter smaller than that of the steel ball so as to prevent the steel ball from slipping out of the radial hole, the locking steel ball is prevented from falling once the stripper cap ring has been assembled. This further facilitates assembly operations.

### BRIEF DESCRIPTION OF THE DRAWINGS

FIG. 1 is a plan view of schematically showing the configuration of a punch press comprising a stripper attaching and removing mechanism for a punch tool according to an embodiment of the present invention.

FIG. 2 is a side view schematically showing the configuration of the punch press.

FIG. 3 is a sectional view of a punch tool and a die tool in the punch press.

FIG. 4A is an enlarged vertical sectional view showing the bottom of the punch guide in the punch tool and FIG. 4B is a partly enlarged view of FIG. 4A.

FIG. 5 is a sectional view taken along line V-V in FIG. 4.

FIG. 6 is an exploded perspective view of a conventional example.

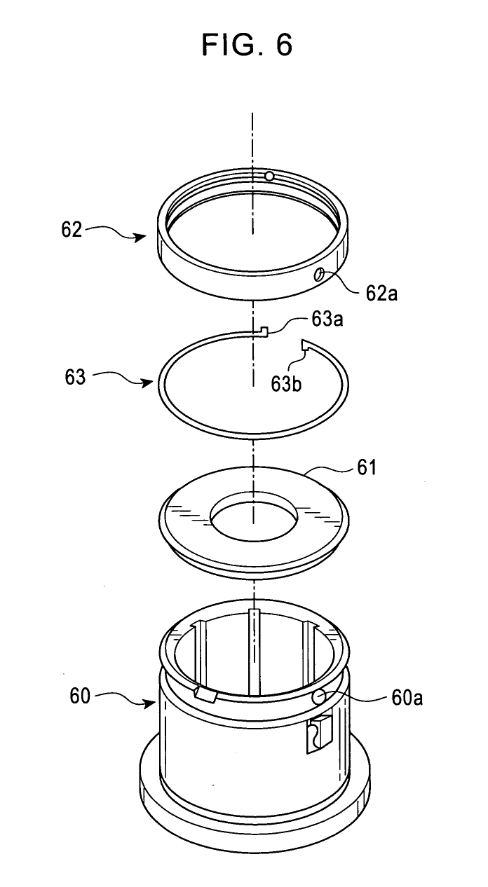

### DETAILED DESCRIPTION OF THE PREFERRED EMBODIMENTS

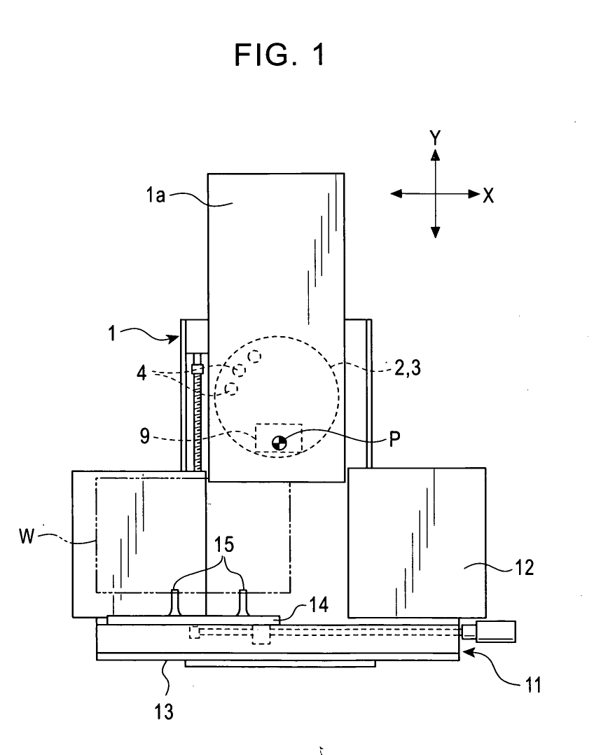

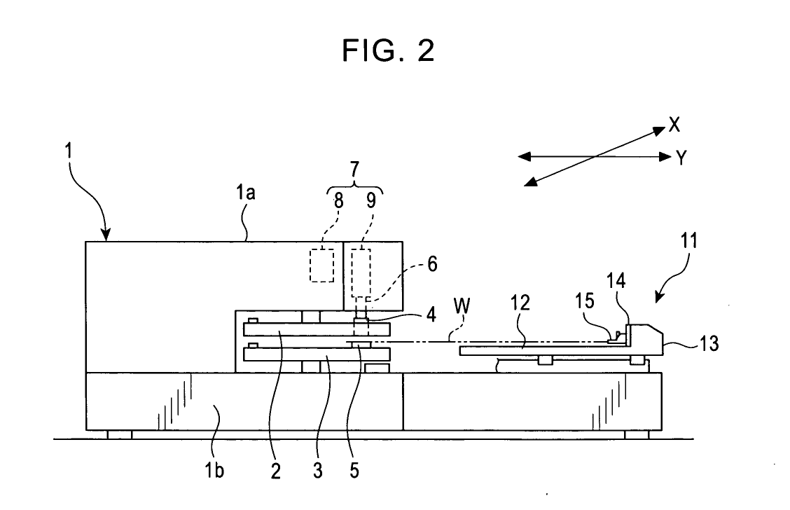

A first embodiment of the present invention will be described with reference to FIGS. 1 to 5. FIG. 1 is a plan view schematically showing the configuration of a punch press on which a punch tool can be mounted according to the first embodiment. FIG. 2 is side view of the configuration.

In the punch press, an upper frame portion 1a and a lower frame portion 1b in a frame 1 support an upper turret 2 and a lower turret 3, respectively, which can be freely rotated around a concentric vertical axis. A plurality of punch tools 4 are arranged on the upper turret 2 in a circumferential direction, whereas a plurality of die tools 5 are arranged on the lower turret 3 in the circumferential direction. When indexed to a punch position P, each of the punch tools 4 is drivingly raised and lowered by a ram 6. The ram 6 is supported in the upper frame portion 1a via a guide member so that the ram 6 can be drivingly raised and lowered by punch machining means 7. The punch machining means 7 punches a plate material W. The upper turret 2 and lower turret 3 are synchronously rotated using a motor (not shown in the drawings). The punch machining means 7 is composed of for example, a servo motor 8 and a motion converting mechanism 9 that converts rotation of the motor 8 into linear motion.

A plate material feeding mechanism 11 is means for feeding an arbitrary part of the plate material W placed on a table 12 to the punch position P. The plate material feeding mechanism 11 has a cross slide 14 installed on a carriage 13 moving forward and backward (Y direction), the cross slide 14 moving rightward and leftward (X direction). Work holders 15 are attached to the cross slide 14 to grip an end of the plate material W.

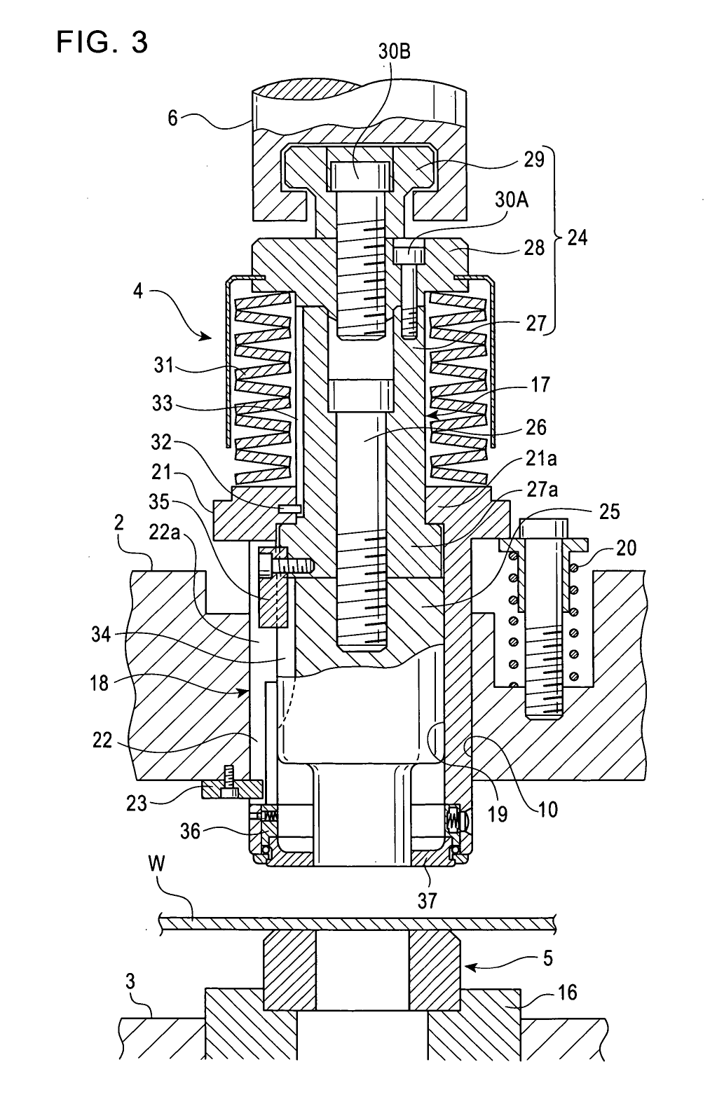

FIG. 3 shows a sectional view of the punch tool 4 and die tool 5 attached to the upper turret 2 and lower turret 3, respectively. The die tool 5 is attached to the lower turret 3 via a die holder 16. Punch tool 4 comprises a punch 17 and a cylindrical punch guide 18 having an inner hole 19 through which the punch 17 can be freely slid. The punch guide 18 is accommodated in a punch tool accommodating hole 10 in the upper turret 2. The punch guide 18 is supported by the upper turret 2 via a rising and returning coil spring 20 so that the punch guide 18 can be freely raised and lowered. The punch guide 18 has a flange-like spring seat 21 at its upper end which receives the coil spring 20 and a coned disc spring 31, described later. A vertically elongate key groove 22 is formed in the outer periphery of the punch guide 18 so as to engage with a key 23 fixed to the bottom surface of the upper turret 2. This regulates the rotating angular position of the punch guide 18 with respect to the punch tool accommodating hole 10.

The punch 17 is composed of a support 24 constituting the upper half of the punch 17 and a punch tip 25 connected to the lower end of the support 24 using a bolt 26. The support 24 is composed of a lower member 27 having a flange portion 27a at its lower end which engages with an inner flange portion 21a of the spring seat 21 of the punch guide 18, a spring seat 28 which is connected to the upper end of the lower member 27 using a bolt 30A and which serves as an intermediate member, and a T-shaped connecting member 29 which is connected to the upper end of the spring seat 28 using a bolt 30B and which serves as an upper member. The T-shaped connecting member 29 forcibly raises the punch 17 and is connected to the ram 6 when the punch tool 4 is indexed to the punch position P (FIG. 1), where punching is carried out. The T-shaped connecting member 29 is not necessarily provided. If the T-shaped connecting member 29 is not provided, the punch 17 returns naturally using the spring 20.

The coned disc spring 31 is interposed between the spring seat 28 of the support 24 and the spring seat 21 of the punch guide 18. The spring constant of the coned disc spring 31 is set larger than that of the coil spring 20. A vertically elongate guide groove 33 is formed in the outer periphery of the lower member 27 so as to engage with a guide pin 32 projected from the inner periphery of the spring seat 21 of the punch guide 18. A key 35 is fixed to the outer periphery of the flange portion 27a of the lower member 27; the key 35 engages with the upper half 22a of the key groove 22 in the punch guide 18 and with a groove 34 formed in the outer periphery of base of the punch tip 25. This regulates the rotating angular position of the support 24 and punch tip 25 with respect to the inner hole 19 in the punch guide 18.

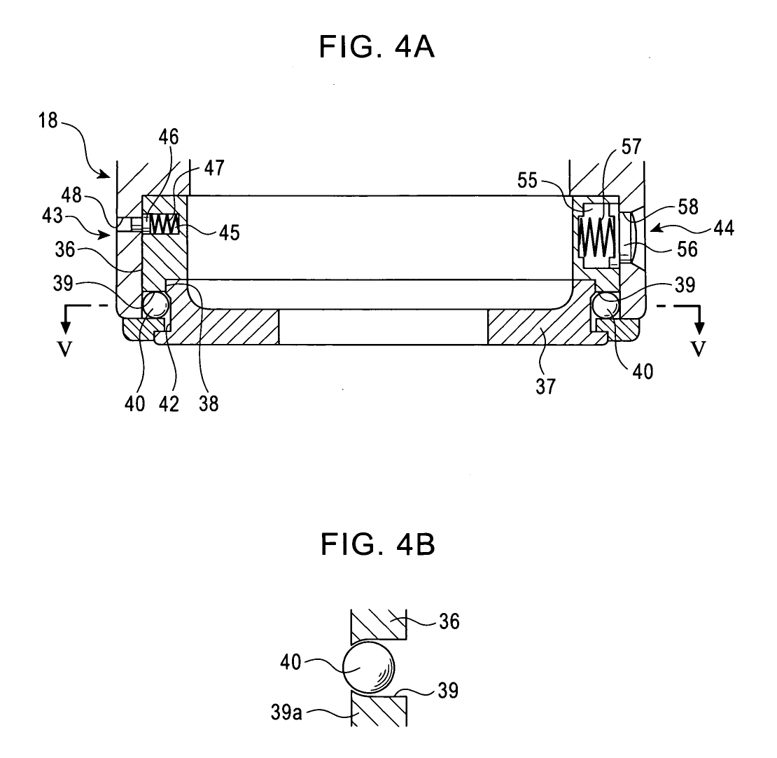

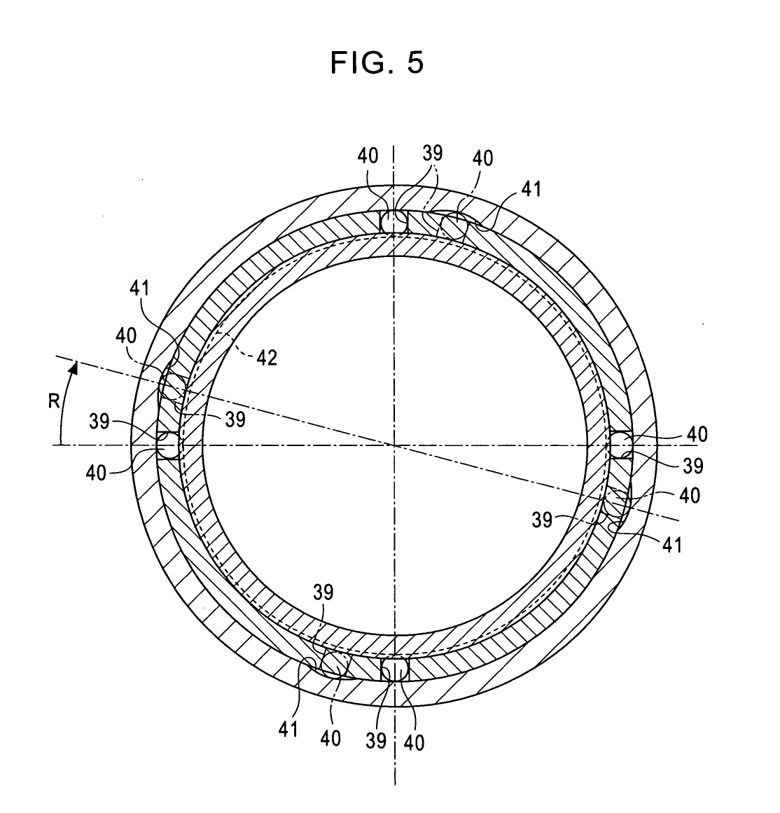

A stripper 37 is detachably held at the lower end of the punch guide 18 via a stripper cap ring 36. As shown in the enlarged vertical sectional view and horizontal sectional view in FIGS. 4 and 5, the stripper cap ring 36 is rotatively movably fitted around the outer periphery of the lower end of the punch guide 18. The stripper cap ring 36 has an inner peripheral hole 38 at its lower end to hold the stripper 37. A plurality of (in this case, four) radial holes 39 are formed in the peripheral wall in the inner peripheral hole 38 in the stripper cap ring 38 so as to penetrate the peripheral wall. Steel balls 40 each having a diameter larger than the thickness of the peripheral wall are inserted into the respective radial holes 39. The radial holes 39 are distributedly spaced from each other through 90 degrees in the peripheral direction as shown in FIG. 5.

The diameter of the opening of each of the radial holes 39 which opening is closer to the stripper 37 is made smaller than that of each of the steel balls 40 by providing a peripheral projecting portion 39a at an edge of the opening as shown in FIG. 4B, and this prevents the steel ball 40 from slipping out of the radial hole 39.

Concave portions 41, 42 that are concave in the radial direction are formed in the outer periphery of the stripper 37 and in the inner periphery of the punch guide 18, respectively, and the steel ball 40 can advance partly into the concave portions 41, 42. A plurality of (in this case, four) the concave portions 41 are formed partly in the punch guide 18 in association with the radial holes 39 in the stripper cap ring 36 so that each of the concave portions 41 is spaced from the adjacent one through an angle of 90 degrees in the peripheral direction. The concave portions 41 are formed in a curved surface having a gently circular horizontal cross section. The concave portion 42 in the stripper 37 is a circumferential groove extending all along the entire circumference. A plurality of (in this case, four) the concave portions 42 may be distributedly formed in the stripper 37 in association with the radial holes 39 in the stripper cap ring 36 so that each of the concave portions 42 is spaced from the adjacent one through an angle of 90 degrees in the peripheral direction.

Stopper means 43 which regulates the rotating angle of the stripper cap ring 36 and stopper means 44 for stopping the rotation are provided between the peripheral wall of the punch guide 18 and the peripheral wall of the stripper cap ring 36. The stopper means 43 for regulating the rotating angle is composed of an engaging pin 46 accommodated in a pin accommodating hole 45 formed in the peripheral wall of the stripper cap ring 36 so that the engaging pin 46 can move into and out of the pin accommodating hole 45, a spring 47 that urges the engaging pin 46 so that the pin 46 projects out from the peripheral wall, and an engaging hole 48 formed in the peripheral wall of the punch guide 18 and with which the engaging pin 46 is engaged. The engaging hole 48 is a slot extending in the peripheral direction. The angle by which the engaging pin 46 can move in the slot is a predetermined angle through which the stripper cap ring 36 is allowed to rotate. The radial hole 39 in the stopper cap ring 36, in which the steel ball 40 is accommodated, can be spaced from the concave portion 41 (for example, the center of the concave portion 41 in the circumferential direction) in the peripheral wall of the punch guide 18 by this predetermined angle, for example, 15 degrees.

The stopper means 44 for stopping the rotation stops rotation of the stopper cap ring 36 with respect to the punch guide 18 so that the radial hole 39 in the stripper cap ring 36 is spaced from the concave portion 41 in the peripheral wall of the punch guide 18 by the predetermined angle. The stopper means 44 for stopping the rotation is composed of engaging member accommodating hole 55 formed at a position different from that of the stopper means 43, used to restrict the rotation angle of peripheral wall of the stripper cap ring 36, an engaging member 56 accommodated in the engaging member accommodating hole 55 so that the engaging member 56 can move freely into and out of the engaging member accommodating hole 55, a spring 57 that urges the engaging member 56 so that the engaging member 56 projects out from the peripheral wall, and an engaging hole 58 formed so as to penetrate the peripheral wall of the punch guide 18 and with which the engaging member 56 is engaged. When the engaging member 56 is pushed into the engaging member accommodating hole 55 against the spring 57 with the operator's finger or the like, the stripper cap ring 36 can be rotated with respect to the punch guide 18.

Operations of the above configuration will be described. The punch tool 4 is indexed to the punch position P. The T-shaped connection member 29 of the punch tool 4 is connected to the ram 6 of the punch machining means 7 (FIG. 1). The ram 6 lowers and the punch tool 4 cooperates with the die tool 5 in punching the plate material W as described below. First, the ram 6 lowers to push down the whole punch tool 4 starting from the upper turret 2, while compressing the coil spring 20. When the stripper 37 of the punch tool 4 is pressed against the plate material W on the die tool 5, the punch guide 18 is stopped. Only the punch 17 then lowers while compressing the coned disc spring 31. The punch 17 thus punches the plate material W. Then, the ram 6 rises to lift the punch 17. At this time, the urging force of the coned disc spring 31 keeps the stripper 37 pressed against the plate material W. This allows the punch 17 to smoothly leave the plate material W. Once the punch 17 rises to a predetermined height, the coned disc spring 31 is decompressed. Thus, subsequently, the whole punch tool 4 rises.

The stripper 37 is removed from the punch guide 18 as described below. The engaging member 56 of the stopper means 44 for stopping the rotation in FIG. 4 is pushed into the engaging member accommodating hole 55 from outside the punch guide 18. This allows the stripper cap ring 36 to rotate freely. Thus, the stripper cap ring 36 is rotatively moved by the predetermined angle (in this case, 15 degrees) in the direction of an arrow R in FIG. 5. Then, the each of the radial holes 39 in the stripper cap ring 36 is located opposite the corresponding concave portion 41 in the punch guide 18 as shown by a chain line. Thus, the steel ball 40 inserted into the radial hole 39 can partly advance into the concave portion 41. The steel ball 40 is disengaged from the concave portion 42 in the stripper 37. The stripper 37 can then be removed from the stripper cap ring 36.

The stripper 37 can be attached by executing the above removal procedure in the reverse order. For attachment, the stripper cap ring 36 is rotatively moved in a direction opposite to that in which the stripper cap ring 36 is rotatively moved for attachment to cause the steel ball 40 to exit the concave portion 41 in the punch guide 18. Since the concave portion 41 has a gently circular horizontal cross section, the steel ball 40 can smoothly exit the concave portion 41. Further, the maximum rotation angle of the stripper cap ring 36 is regulated by the stopper means 43 for regulating the rotation angle.

To pull the stripper cap ring 36 out of the punch guide 18 in order, for example, to disassemble the mechanism for maintenance or to replace the steel ball 40, the engaging pin 46 of the stopper means 43 for regulating the rotation speed is pushed into the pin accommodating hole 45. Further, the engaging member 56 of the stopper means 44 for stopping rotation is pushed in. The engaging hole 48, which is composed of a slot and with which the engaging pin 46 is engaged, is so small in the axial direction of the punch guide 18 that the operator's finger cannot be put in the engaging hole 48. Accordingly, a tool is used to push in the engaging pin 46. In this state, clamping engaging member 56 is pushed in with the operator's finger to allow the stripper cap ring 36 to be slipped out.

As described above, in the stripper attaching and removing mechanism for the punch tool 4, the steel balls 40 are inserted into the respective radial holes 39 formed in the peripheral wall of the stripper cap ring 36. Further, the concave portions 41, 42 are formed in the punch guide 18 and stripper 37 so as to be concave in the radial direction and so that the steel balls 40 can partly advance into the concave portions 41, 42. Accordingly, a rotating operation enables the stripper 37 to be easily attached and removed. The components of the stripper attaching and removing mechanism can be easily assembled together. Further, steel balls 40 are commercially easily available, thus enabling costs to be reduced.

Further, the plurality of radial holes 39 in the stripper cap ring 36 are spaced from one another in the peripheral direction. The plurality of concave portions 41 in the punch guide 18 are formed in the peripheral direction in association with the radial holes 39. Consequently, the stripper 37 can be reliably supported at the plurality of positions.

The opening of each of the radial holes 39 in the stripper cap ring 36 which opening is closer to the stripper 37 has a diameter smaller than that of the steel ball 40 so as to prevent the steel ball 40 from slipping out of the radial hole. Consequently, even when the stripper 37 is removed from the stripper cap ring 36, the steel ball 40 does not fall from the radial hole 39. This facilitates the subsequent attachment of the stripper.

Further, the steel balls 40 are used instead of directional solid members. This has the following advantages.

During assembly, the steel balls 40 can be inserted into the radial holes 39 without paying attention to the directions of the steel balls 40.

When the stripper cap ring 36 is rotated in order to remove or attach the stripper 37, the steel balls 40 can rotate by themselves. This allows the stripper cap ring 36 to rotate smoothly.

When the stripper 37 is removed by rotating the stripper cap ring 36 to locate the steel balls 40 opposite the respective concave portions 41 in the punch guide 18 and then pulling the stripper 37 from the punch guide 18, each of the concave portions 42 in the stripper 37 pushes the engaged portion of spherical surface of the corresponding steel ball 40. This allows the steel ball 40 to escape in the radial direction.

1. A stripper attaching and removing mechanism for a punch tool comprising a punch guide having an inner hole through which a punch can be slid and having a lower end to and from which a stripper can be attached and removed, the stripper attaching and removing mechanism being characterized by comprising a stripper cap ring rotatively movably fitted into an inner periphery of a lower end of the punch guide, the stripper cap ring having an inner peripheral hole used to hold a stripper, and a radial hole formed in a peripheral wall of the stripper cap ring and into which steel balls each having a diameter larger than the thickness of the peripheral wall are inserted, the stripper and the punch guide having a concave portion into which said steel ball can partly advance and which is concave in a radial direction, the concave portion being formed partly in the punch guide in a peripheral direction.

2. A stripper attaching and removing mechanism for a punch tool according to claim 1, characterized in that a plurality of the radial holes are formed in the stripper cap ring so as to be spaced from one another in a circumferential direction, and a plurality of the concave portions are formed in the punch guide in the peripheral direction in association with the radial holes.

3. A stripper attaching and removing mechanism for a punch tool according to claim 1, characterized in that an opening of each of the radial holes in the stripper cap ring which opening is closer to the stripper has a diameter smaller than that of the steel ball so as to prevent the steel ball from slipping out of the radial hole.

4. A stripper attaching and removing mechanism for a punch tool according to claim 2, characterized in that an opening of each of the radial holes in the stripper cap ring which opening is closer to the stripper has a diameter smaller than that of the steel ball so as to prevent the steel ball from slipping out of the radial hole.
